(19) United States
(12) Patent Application Publication
(10) Pub. No.: US 2026/0204242 A1
(43) Pub. Date: Jul. 16, 2026

(54) DIFFUSION INFERENCE-TIME T-OPTIMIZATION FOR MUSIC GENERATION

(71) Applicant: Adobe Inc., San Jose, CA (US)

(72) Inventors: Zachary NOVACK, San Diego, CA (US); Nicholas J. BRYAN, Belmont, CA (US)

(73) Assignee: Adobe Inc., San Jose, CA (US)

(21) Appl. No.: 19/020,980

(22) Filed: Jan. 14, 2025

(51) Int. Cl. G10H 1/00; G06N 3/084

(52) U.S. Cl. CPC G10H 1/0025; G06N 3/084; G10H 2210/031; G10H 2210/111; G10H 2210/131; G10H 2250/311

(57) ABSTRACT

Embodiments are disclosed for music generation. The method may include receiving a text input describing music to be generated by a neural network and obtaining an initial noise laten. The neural network generates a music spectrogram based on the initial noise latent and the text input. One or more features are extracted from the music spectrogram. A loss is determined based on the one or more features from the music spectrogram and one or more target features of a target output. An optimized noise latent is obtained based on the loss and a new music spectrogram is generated using the optimized noise latent.

### BACKGROUND

Recently, there has been an increase of interest in diffusion models. These models typically allow for realistic images to be generated based on text prompts. This has enabled creators of varying skill levels to convert high-level intent into images which may then be incorporated into other creative work. For example, large-scale diffusion generative models have transformed the creative landscape across a range of modalities and have begun to show promising results for text-to-music generation.

### SUMMARY

Introduced here are techniques/technologies that enable music generation via inference-time optimization and inference-time compute. Embodiments include a music generation system which includes a diffusion model. The diffusion model can sample noise to obtain an initial latent and process that latent over a number of steps to generate a visual representation of music. For example, the diffusion model may be a text-to-spectrogram model which receives a text prompt describing music to be generated and produces a spectrogram that represents the generated music. While such techniques allow for high-level control of the music being generated, precise control is more challenging.

In one or more embodiments, precise control over the music generation process is enabled by optimizing the initial latent. For example, controls over musical features, such as melody, structure, intensity, etc. are implemented through this latent optimization. In particular, feature(s) are extracted from the generated music data and compared to target music data, such as from previously generated music data, reference music data etc. A loss function corresponding to the feature(s) is used to determine a loss value which can be backpropagated through the network and used to determine an optimized latent. This optimized latent can then be used to generate new music data whose features more closely track those of the reference music. This process may continue as needed until, e.g., the loss is below a threshold value, the generated music is deemed satisfactory by the user, or other end condition.

In some embodiments, this backpropagation is facilitated using checkpointing for memory management. This checkpointing enables intermediate data, such as activation values, to be discarded and recalculated only when needed. This greatly reduces the memory footprint of the model and enables the latent optimization to be performed.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of inference-time optimization for music generation in accordance with one or more embodiments;

FIG. 2 illustrates a diagram of a framework for inference-time control of pre-trained diffusion models in accordance with one or more embodiments;

FIG. 3 illustrates a diagram of backpropagation memory management in accordance with one or more embodiments;

FIG. 4 illustrates an example user interface for music extension, in accordance with one or more embodiments;

FIG. 5 illustrates an example user interface for music remixing, in accordance with one or more embodiments;

FIG. 6 illustrates example target and generated music features, in accordance with one or more embodiments;

FIG. 7 illustrates a schematic diagram of music generation system in accordance with one or more embodiments;

FIG. 8 illustrates a flowchart of a series of acts in a method of music generation in accordance with one or more embodiments; and

FIG. 9 illustrates a block diagram of an exemplary computing device in accordance with one or more embodiments.

### DETAILED DESCRIPTION

One or more embodiments of the present disclosure include a music generation system which includes a general-purpose framework for controlling pre-trained text-to-music diffusion models at inference-time via optimizing initial noise latents. This allows for generation of music that matches a target style using various differentiable loss functions at inference-time to optimize the latent that is sampled to start the diffusion process, without requiring any fine-tuning or training of the diffusion model. Additionally, an improved gradient checkpointing system is used for memory efficiency.

Large-scale diffusion models have emerged as a leading paradigm for generative media, with strong results in diverse modalities such as text-to-image (TTI) generation, video generation, and 3D object generation. Recently, there has been growing work in applying image-domain methods to audio by treating the frequency domain spectrograms of audio as images, producing promising results in general text-to-audio (TTA) generation and text-to-music generation. These techniques operate via pixel or latent diffusion over spectrograms with genre, mood, and/or keywords control articulated via text prompts.

However, these existing techniques typically only provide high level control. Attempts to add precise control have proven to be more challenging. For example, some existing techniques that add precise control require large-scale training paired examples and fix the control signal at training time. Such training requires significant resources to perform the training itself as well as to construct an adequate training dataset. The expense associated with model training or fine-tuning can be avoided by adding controls at inference-time. However, existing inference-time techniques which guide the diffusion sampling process struggle on fine-grained expressivity due to relying on approximations of the model outputs during sampling.

For example, some inference-time techniques, such as prompt-to-prompt image editing and MultiDiffusion, enable localized object replacement, inpainting, outpainting, and spatial-guidance control by fusing multiple masked diffusion paths together. Such methods rely on control targets that can be localized to specific pixel regions of an image and are less applicable for audio spectrograms which have indirect pixel correspondences across frequency and multiple overlapping sources at once. Additionally, guidance-based methods add updates at each sampling step to steer generation via the gradient of a pre-trained classifier. However, these guidance-based techniques either require an approximation of model outputs, which limits fine-grained expressivity, or pre-trained classifiers, which defeats the purpose of inference-time efficiency.

Recent work has shown optimization through diffusion sampling is possible if GPU memory is managed appropriately. For example, direct optimization of diffusion latents (DOODL) leverages the EDICT sampling algorithm, which uses affine coupling layers (ACLs) to form a fully invertible sampling process, and backpropagates through EDICT to optimize initial diffusion noise latents for improving CLIP guidance, vocabulary expansion, and aesthetic improvement. DOODL, however, struggles with fine-grained control signals and has multiple downsides due to its reliance on EDICT. For example, DOODL is restricted to only invertible diffusion sampling algorithms and requires double the model evaluations for both forward and reverse sampling that increase latency and memory use. Additionally, DOODL can suffer from stability issues and reward hacking due to divergence between the ACL diffusion chains.

Another technique, diffusion noise optimization (DNO), has proposed backpropagating through the sampling process for human motion generation, operating over short sequences of limited joint positions. This work leverages numerous domain-specific modifications to reduce memory usage, such as using a small (i.e. <18M parameters) transformer encoder-only architecture, very few sampling steps, long optimization time, and purely unconditional generation. However, the domain-specific modifications required by this approach make it unsuitable for more standard generative tasks with higher memory demands like text-to-image, text-to-audio, and text-to-music.

To address the shortcomings of existing techniques, embodiments optimize the initial noise latents x_{T} with respect to an arbitrary feature matching loss across any differentiable diffusion sampling process to achieve a desired (e.g., stylized) output. Additionally, efficient memory use is assured via gradient checkpointing. Although the noise latents are generally thought to encode little information, optimizing the initial noise latents enables the diffusion process to be controlled for a wide-variety of applications in music creation, enabling musically-salient feature control and high-quality audio editing. Compared to previous optimization-based works from outside the audio domain, embodiments achieve state of the art control while also being twice as time and memory efficient.

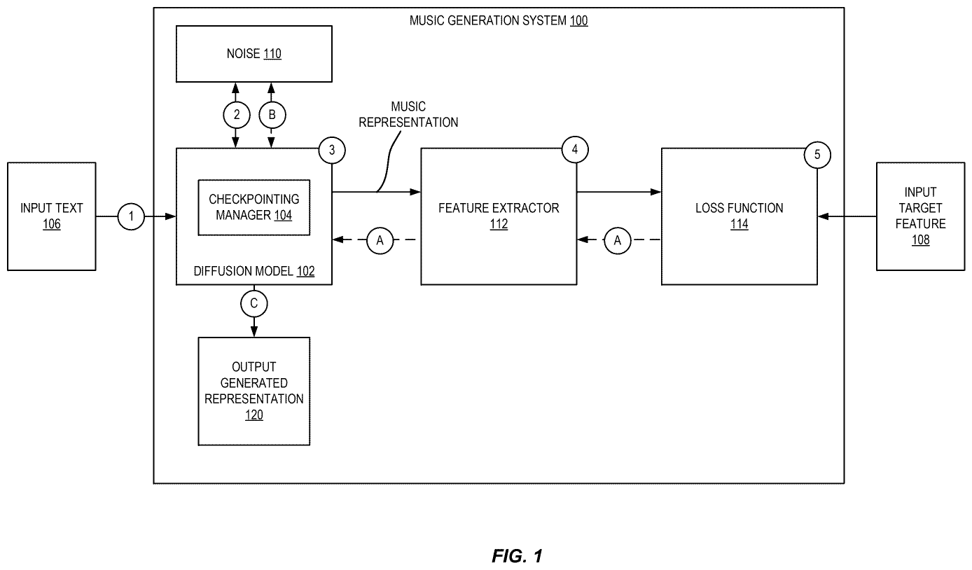

FIG. 1 illustrates a diagram of a process of inference-time optimization for music generation in accordance with one or more embodiments. The example of FIG. 1 includes a music generation system 100. Music generation system 100 can be implemented in various computing environments (e.g., a cloud-based application, a standalone application executing on an end user device, etc.). As such, the elements shown in the example of FIG. 1 may be executing on the same computing device and/or execution may be spread across components executing on diverse local and/or remote computing devices.

As shown in FIG. 1, the music generation system 100 can include a pre-trained diffusion model 102. In the example of FIG. 1, the pre-trained diffusion model 102 can be any diffusion model trained to generate a visual, audio, or latent representation of music from a text input. For example, the pre-trained diffusion model 102 may be a text-to-spectrogram model or a text-to-latent diffusion model that is paired with a latent decoder. The pre-trained diffusion model 102 may be implemented using neural networks, such as a U-net architecture, a transformer architecture, etc.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As discussed, memory management is important for diffusion sampling optimization techniques. As such, the pre-trained diffusion model 102 includes checkpointing manager 104. Standard backpropagation requires the inputs, outputs, and intermediate activations for each iteration of the model to be stored in memory. This can lead to a prohibitively large memory footprint. Accordingly, the checkpointing manager implements a gradient checkpointing system that allows for backpropagation to be performed without storing the intermediate activations. Instead, the inputs and outputs are stored and can be retrieved from memory as needed to recalculate the intermediate activations during backpropagation. This greatly reduces the memory footprint as the inputs and outputs are relatively small, especially when compared to the size of the intermediate activations. While this requires additional forward passes of the model to perform recalculation during backpropagation, this is limited to double the model calls, preserving a fast runtime.

As shown in FIG. 1, at numeral 1, a text prompt 106 is received by the diffusion model 102. This may be received via a user interface, e.g., via mouse and keyboard, voice to text, or other user input. The diffusion model 102 can then obtain an initial noise latent at numeral 2 by sampling a noise space 110 (e.g., Gaussian noise, etc.). The diffusion model can then be run iteratively until a representation of music is generated at numeral 3. In various embodiments, the representation of music (also referred to as a music representation) can be audio, pixel data, latent vectors, etc. This can then be provided to feature extractor 112. In some embodiments, the feature extractor receives generated audio data. As such, if the music representation is a non-audio representation (e.g., pixel data, latent vectors, etc.), it may first be converted into audio data (e.g., using a decoder, vocoder, etc.) before being provided to the feature extractor. At numeral 4, the feature extractor extracts a musical feature from the representation. Although a single feature extractor 112 is shown in FIG. 1, in various embodiments one or more feature extractors may be used. The feature extractors can extract features such as melody, intensity, music structure, etc.

At numeral 5, a loss function 114 compares the extracted feature from the generated representation to a target feature 108. The target feature 108 may be extracted from a reference music, may be a synthetically generated feature, etc. The loss is then backpropagated as shown at A. This backpropagation can include going through the same number of iterations of the model using the checkpointing manager to recalculate the intermediate activations as needed based on stored inputs and outputs, as discussed. At B, an optimized initial noise latent is obtained based on the loss. In some embodiments, the optimized initial noise latent may then be used to generate the output representation 120, which can then be transformed into audio, added to a reference audio track, or other applications, as discussed. Alternatively, this process may be run iteratively until the loss is below a threshold value and the corresponding music representation is then used as output.

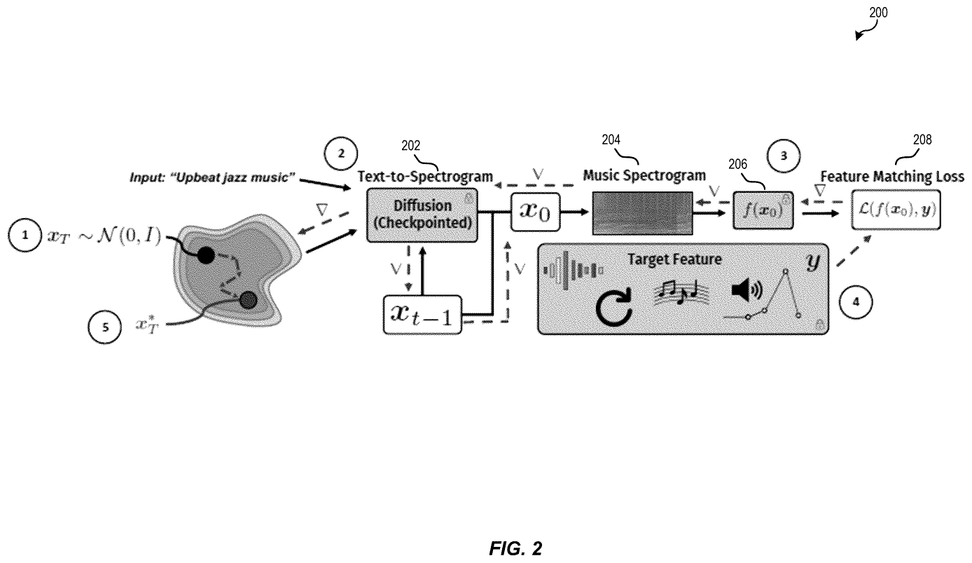

FIG. 2 illustrates a diagram of a framework 200 for inference-time control of pre-trained diffusion models in accordance with one or more embodiments. Denoising diffusion probabilistic models (DDPMs) or diffusion models can be characterized by a forward and reverse random Markov process. The forward process takes clean data and iteratively corrupts it with noise to train a neural network ϵₑ. The network ϵ_{θ} typically inputs (noisy) data xₜ, the diffusion step t, and (text) conditioning information cₜₑₓₜ. The reverse process takes random noise x_{T}~ [symbol] (0, I), as shown at numeral 1 in FIG. 2, and iteratively refines it with the learned network to generate new data x₀ over T time steps (e.g., 1000) via the sampling process:

$${x}_{t - 1} = \frac{1}{\sqrt{{α}_{t}}} ( {x}_{t} - \frac{\sqrt{1 - {α}_{t}}}{\sqrt{1 - {\overline{α}}_{t}}} {ϵ}_{θ} ( {x}_{t} , t , {c}_{text} ) ) + {σ}_{t} ϵ \qquad ( 1 )$$

where ϵ~ [symbol] (0, I), α₀:=1, αₜ and α̅ₜ define the noise schedule, σₜ is the sampling standard deviation. This iterative loop is depicted at numeral 2 in FIG. 2. For example, the trained diffusion model (e.g., text-to-spectrogram model 202) is run iteratively until new music representation x₀ is generated. In the example of FIG. 2, the music representation is a music spectrogram 204. To reduce sampling time, Denoising Diffusion Implicit Model (DDIM) sampling uses an alternative optimization objective that yields a faster sampling process (e.g., 20-50 steps) that can be deterministic.

To improve text conditioning, classifier-free guidance (CFG) can be used to blend conditional and unconditional generation outputs. When training with CFG, conditioning is randomly set to a null value a fraction of the time. During inference, the diffusion model output ϵ_{θ}(xₜ, t, cₜₑₓₜ) is linearly combined with ϵ_{θ}(xₜ, t, c_{ø}) using the CFG scale w, where c_{ø}0 are null embeddings. As discussed, CFG during inference doubles the forward passes of ϵ_{θ}.

Though x is typically considered as only a random seed, embodiments leverage x_{T} for fine-grained control over the generative process. Embodiments treat the task of controlling pre-trained diffusion models as an optimization problem where the initial state, or latents, of the diffusion sampling process are fit to generate a desired output given a control signal. Formally, this can be expressed as:

$${x}_{T}^{*} = arg {min}_{{x}_{T}} ℒ ( f ( {x}_{0} ) , y ) \qquad ( 2 )$$

$${x}_{t - 1} = Sampler ( {ϵ}_{θ} , {x}_{t} , t , c ) , t = T , T - 1 , … , 1 \qquad ( 3 )$$

where ϵ_{θ} is a pre-trained diffusion model that inputs conditioning information c, Sampler is any differentiable diffusion sampling algorithm (e.g. DDIM, etc.), xₜ is a sample of a Gaussian random vector ~ [symbol] ∇(0, I) otherwise known as initial noise latents, x_{T} is the final generated output of the sampler (e.g. an image or image representation of audio), ƒ(⋅) is any differentiable feature extraction function, [symbol] is any differentiable loss function, and y are target features or the desired outputs. For example, as shown at numeral 3 in FIG. 2, one or more features of the audio representation are extracted by feature extractor(s) 206. A feature matching loss function 208 calculates a loss between the extracted feature(s) and one or more target features from a target music representation, as shown at numeral 4. By framing the control task an as arbitrary feature-matching optimization problem on the initial noise latents, a diverse range of control tasks can be incorporated.

An optimized latent

$${x}_{T}^{*}$$

can then be determined by backpropagating the calculated loss, as shown at numeral 5 in FIG. 2. However, solving equation (2) using backpropagation is typically intractable due to extreme memory requirements. In particular, the diffusion sampling process is recursive by design and standard automatic differentiation packages customarily require storing all intermediate results for each of T recurrent calls to Ee within the sampler (2T sets of activations per step when CFG is used). Thus, even 2-3 sampling steps can cause memory errors with standard U-Net diffusion or transformer architectures.

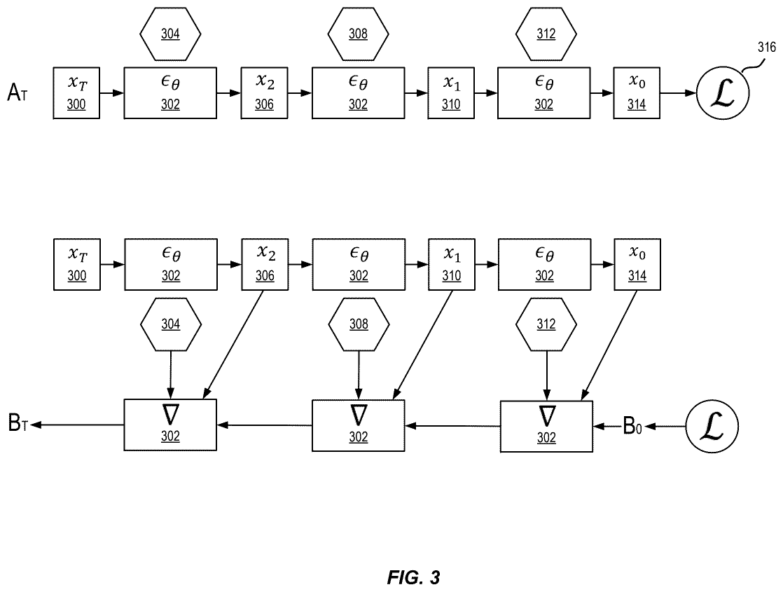

FIG. 3 illustrates a diagram of backpropagation memory management in accordance with one or more embodiments. Embodiments use gradient checkpointing to circumvent large memory use during optimization. Gradient checkpointing was introduced to save memory when training very deep or recursive neural networks by trading memory cost for compute time. One aspect of gradient checkpointing is to discard intermediate activation values stored during the forward pass of backpropagation that inflict high memory use and/or which are low cost to recompute during the backward pass when needed from cached inputs.

Embodiments use gradient checkpointing on each diffusion model call during sampling, as the memory required to store the intermediate noisy diffusion tensors and conditioning information is minute compared to the intermediate activations of a typical diffusion model (e.g., cross-attention activation maps within a large UNet). In some embodiments, the memory cost to optimize equation (2) with sampler-step checkpointing is 1) the memory needed to run backpropagation on one diffusion model call ϵ_{θ} plus 2) the cost to store the T intermediate noisy diffusion tensors xₜ ∀t=0, . . . , T and conditioning c. This memory reduction comes at the cost of an additional forward pass of the sampling process or T diffusion model calls as shown in FIG. 3.

For example, in the forward pass A_{T}, the trained model 302 is called with checkpointing at each step 0 to T. At each step, the input and output of the trained model is stored. In the example of FIG. 3, that means x_{T} 300, x₂ 306, x₁ 310, and x₀ 314 are all stored, while the intermediate activation values represented by 304, 308, and 312 are all discarded. Differentiable loss function 316 is then used to calculate a feature-based loss value which is backpropagated through the network. Because the inputs and outputs were stored, any missing values can be recalculated during backpropagation. For example, another forward pass of the trained model 302 can be run using x₁ 310 to recalculate x₀ 314 and activation values 312. Likewise, additional forward passes can be run to recalculate activation values 308 and 304 along with x₂ 306, x₁ 310. This results in T additional diffusion model calls during backpropagation, but saves a significant memory footprint as the activation values do not have to be stored.

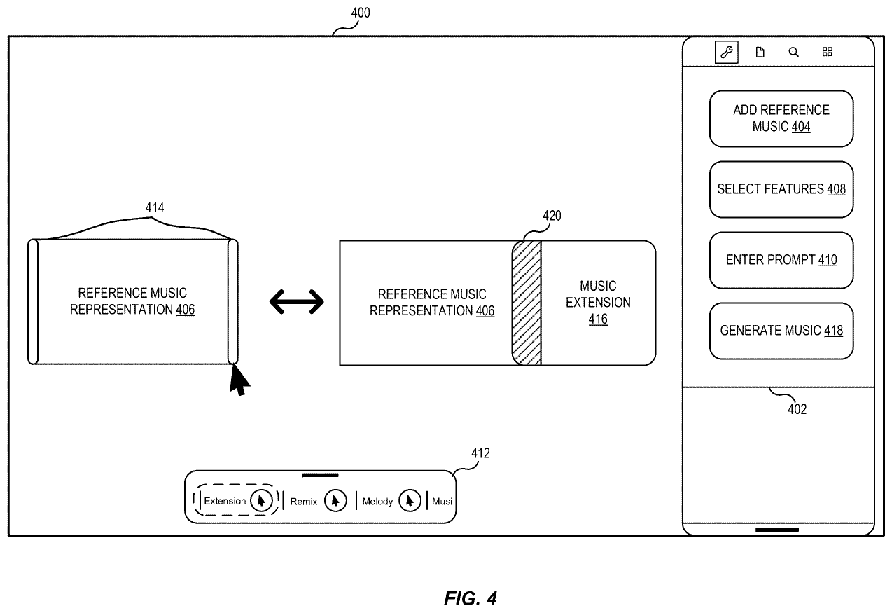

FIG. 4 illustrates an example user interface 400 for music extension, in accordance with one or more embodiments. Outpainting is the task of extending the length of real or previously generated content and is critical for image and audio editing as well as generating long duration music content using diffusion models. Past outpainting methods struggle to maintain long-form coherence and local smoothing. Embodiments perform outpainting (e.g., music extension) by taking an existing reference audio signal x_{ref} and defining an overlap region in seconds at the end of the reference. The music generation system can then be used to create new content that matches the overlap region and extends it. The generated content is then stitched to the reference content to form the extended music. More formally, M_{ref} and M_{gen} are defined as binary masks that specify the location of the overlap region in the reference and generated content respectively,

$$f ( {x}_{0} ) := {M}_{g e n} ⊙ {x}_{0} , y = {M}_{r e f} ⊙ {x}_{r e f} , and ℒ ∝ {‖ f ( {x}_{0} ) - y ‖}_{2}^{2} .$$

As shown in FIG. 4, a user interface for a music generation system can enable a user to generate music for various applications. For example, the user interface 400 can include a panel 402 that enables the user to upload reference music 404. This may include selecting a music file (e.g., stored locally or remotely) to be used as a target for the music generation system, as discussed. As shown in FIG. 4, when a reference music file has been selected, a representation of the reference music 406 is added to the user interface's workspace. Although the example of FIG. 4 has been described with respect to a reference music file being selected, in some embodiments the reference music is itself generated (e.g., by the music generation system or other system). In such instances, the reference music may be generated based on the text prompt 410 and then extended as discussed.

Additionally, the user may select one or more features 408 of the reference music to be used specifically for targeting. For example, the same reference music may be used to target music structure and melody. Alternatively, one reference music may be used to target melody while a second reference music may be used to target intensity. The panel 402 may also enable a text prompt to be entered for use during music generation. As discussed, the text prompt may describe the music to be generated (e.g., genre, mood, tempo, etc.).

In some embodiments, the user interface 400 may also include a panel 412 which includes specific application tools. These may allow for portions of the reference music to be selected within the user interface for targeted generation. In the example of FIG. 4, the user selects extension. This causes music to be generated which adds to the reference music representation. For example, when extension is selected, selectable elements 414 at the beginning and end of the representation of the reference music 406 may be added. These can be interacted with (e.g., clicked, tapped, etc.) to create a music extension area 416. Once the music extension area 416 has been selected, the user can then select generate music 418 from panel 402, which invokes the music generation system to perform the techniques described herein to generate music to be added to the reference music. For example, overlap region 420 is identified and new music is generated with features that are targeted to match the features of the overlap region 420. In some embodiments, the length of the overlap region may be fixed. Alternatively, the length of the overlap region may be specified by the user by interacting with selectable elements 414.

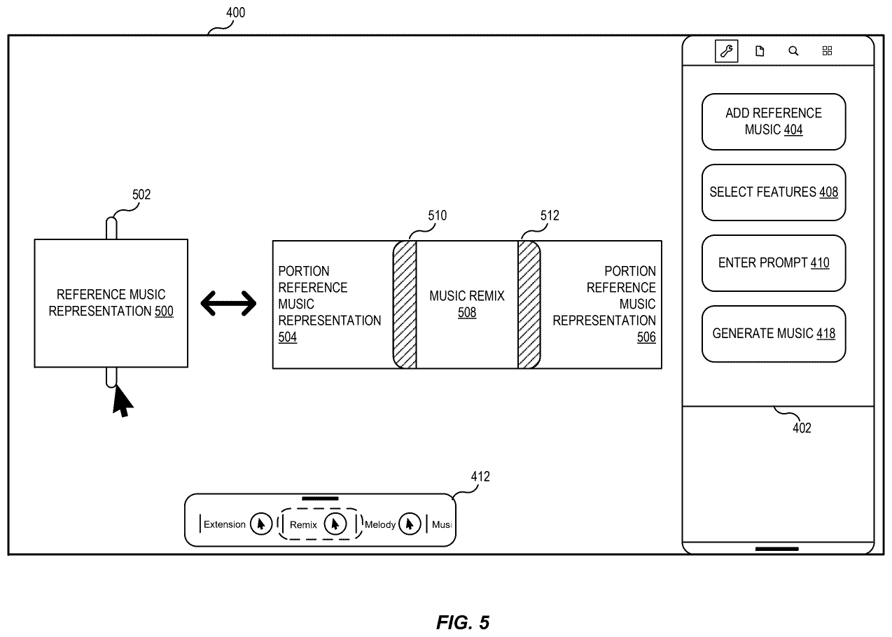

FIG. 5 illustrates an example user interface 400 for music remixing, in accordance with one or more embodiments. Inpainting (e.g., remixing) is the task of replacing an interior region of real or previously generated content and is essential for audio editing and music remixing. Embodiments perform inpainting similar to outpainting, with the only modification being M_{ref}=M_{gen} denote two overlap regions (on each side of the spectrogram) to use as context for inpainting the gap in between.

Similar to the example shown in FIG. 4, embodiments may also be used for remixing portions (also referred to as regions) of music. When the user selects the remix tool, a selectable element 502 may be overlaid on the reference music representation 500. This selectable element 502 can be moved to the appropriate location and expanded in size to cover the length of music to be added. This effectively divides the reference music into two portions, a leading portion 504 and a following portion 506. In some embodiments, the remix portion 508 may also extend the reference music (e.g., be longer than the portion it is replacing). Alternatively, the remix portion 508 may be the same length as the reference. As discussed, the two overlapping portions 510 and 512 are identified and, similar to the example of FIG. 4, are used to generate the remixed music content. For example, features of the overlapping portions 510, 512 may be extracted and used by the music generation system for targeted music generation, as discussed.

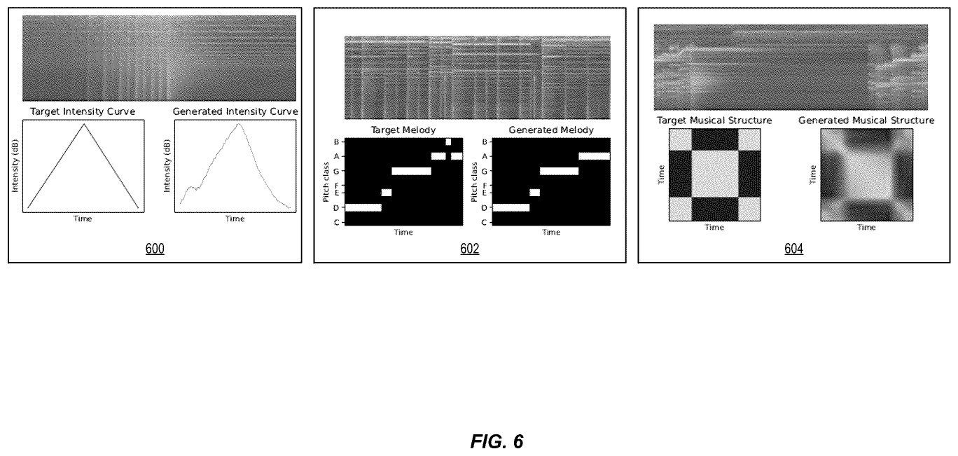

FIG. 6 illustrates example target and generated music features, in accordance with one or more embodiments. As discussed, embodiments enable control of various musical features by changing the differentiable loss function and feature extractors in use. For example, as shown at 600, one such feature is music intensity. Musical intensity control is the task of adjusting the dynamic contrast of generated music across time. In some embodiments, the intensity control protocol from Music ControlNet is used, which employs a training-time method to generate music that follows a smoothed, decibel (dB) volume curve. The music generation system can control intensity without the need for large-scale fine-tuning, by setting ƒ(x₀):=w*20 log₁₀(RMS(V(x₀)) where w are the smoothing coefficients used in Music ControlNet, * is a convolution operator, RMS is the Root Mean Squared energy of the audio, y is a given dB-scale target curve,

$$ℒ ∝ {‖ f ( {x}_{0} ) - y ‖}_{2}^{2} ,$$

and V is a vocoder that translates spectrograms to the audio domain. In some embodiments, backpropagation is performed through the vocoder as well.

As shown at 602, another controllable feature is musical melody. Musical melody control is the task of controlling prominent musical tones over time and allows creators to generate accompaniment music to existing melodies. The approximate melody of a recording can be extracted by computing the smoothed energy level of the 12-pitch classes over time via a high pass chromagram function C(⋅). Given this, we the music generation system can use a feature extractor of ƒ(x₀)=log(C(V(x₀))), a target melody y∈{1, . . . , 12}^{N×1}, the spectrogram length N, and [symbol] =NLLLoss(ƒ(x₀), y) or the negative log likelihood loss.

As shown at 604, another controllable feature is musical structure. Musical structure control is the task of controlling the high-level musical form of generated music over time. To model musical form, musical structure analysis work measures structure via computing a self-similarity (SS) matrix of local timbre features where timbre is “everything about a sound which is neither loudness nor pitch”. Thus, the music generation system can be used for musical structure control by setting y to be a known, target SS matrix, ƒ(x₀)=T(x₀)T(x₀)^{T}, T(⋅) to be a timbre extraction function, and

$$ℒ ∝ {‖ f ( x 0 ) - y ‖}_{2}^{2} .$$

Specifically, some embodiments use the Mel-Frequency Cepstrum Coefficients (MFCCs), omitting the first coefficient and normalized across the time axis, as the timbre extraction function, and then smooth the SS matrix via a 2D Savitzky-Golay filter in order to not penalize slight variations in intra-phrase similarity. Such target SS matrices can take the form of an “ABBA” pattern (as shown at 604) for instance.

Another controllable feature is looping. Looping is the task of generating content that repeats in a circular pattern, creating repeatable music fragments to form the basis of a larger composition. In some embodiments, looping is performed by defining M_{ref} and M_{gen} as two overlapping edge regions of the output (e.g., similar to inpainting) but corresponding to opposite sides of the outputs (e.g., similar to outpainting), such that the extended region seamlessly transitions back to the beginning of the reference clip.

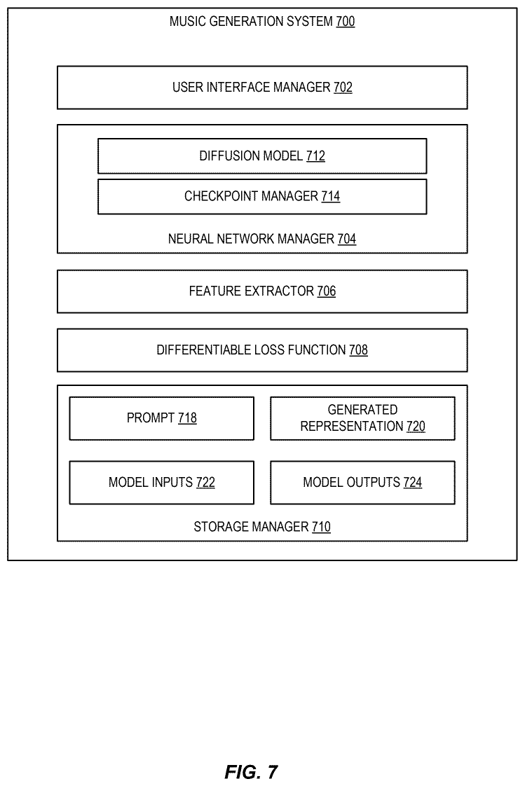

FIG. 7 illustrates a schematic diagram of a music generation system (e.g., “music generation system” described above) in accordance with one or more embodiments. As shown, the music generation system 700 may include, but is not limited to, user interface manager 702, neural network manager 704, feature extractor 706, differentiable loss function 708, and storage manager 710. The neural network manager 704 includes diffusion model 712 and checkpoint manager 714. The storage manager 710 includes prompt 718, generated representation 720, model inputs 722, and model outputs 724.

As illustrated in FIG. 7, the music generation system 700 includes a user interface manager 702. For example, the user interface manager 702 allows users to provide input music data, prompt text, etc. to the music generation system 700. In some embodiments, the user interface manager 702 provides a user interface through which the user can enter a prompt 718 which describes the music to be generated, as discussed above. Additionally, the user interface enables the user to provide music data to be used as a reference to control the generation of the music. Alternatively, or additionally, the user interface may enable the user to download the music data from a local or remote storage location (e.g., by providing an address (e.g., a URL or other endpoint) associated with a music source). In some embodiments, the user interface can enable a user to link an audio capture device, such as a microphone or other hardware to capture music data and provide it to the music generation system 700.

Additionally, the user interface manager 702 allows users to request the music generation system 700 to edit the generated music such as by outpainting (e.g., music extension), inpainting (e.g., music remixing), looping, etc. In some embodiments, the user interface manager 702 enables the user to view the resulting representation of music (e.g., spectrograms, etc.) and/or listen to the generated music following transformation by a vocoder, etc.

As illustrated in FIG. 7, the music generation system 700 also includes a neural network manager 704. Neural network manager 704 may host a plurality of neural networks or other machine learning models, diffusion model 712. The neural network manager 704 may include an execution environment, libraries, and/or any other data needed to execute the machine learning models. In some embodiments, the neural network manager 704 may be associated with dedicated software and/or hardware resources to execute the machine learning models. Although depicted in FIG. 7 as being hosted by a single neural network manager 704, in various embodiments the neural networks may be hosted in multiple neural network managers and/or as part of different components. For example, each network can be hosted by their own neural network manager, or other host environment, in which the respective neural networks execute, or the networks may be spread across multiple neural network managers depending on, e.g., the resource requirements of each network, etc.

The checkpoint manager 714 implements a checkpointing function, as described above. For example, the checkpointing function can store inputs and outputs of the diffusion model for each diffusion step. If the diffusion model has default activation caching, the checkpointing manager 714 overrides this behavior allowing the activation values to be discarded. During backpropagation, the activation values are recomputed as needed in the backward pass.

The checkpointing technique implemented by checkpoint manager 714 stands in contrast to existing techniques. For example, while DOODL uses a gradient checkpointing technique, it requires the use of the EDICT sampling algorithm. This splits the sampling process into two non-parallelizable update equations per sampling step. As a result, DOODL requires more than double the memory and runtime cost (e.g., it requires double the number of model calls per step). Additionally, DOODL suffers from overall instability during the sampling process (particularly at low sampling steps) due to EDICT's “mixing” layers to align the correlated updates.

As illustrated in FIG. 7, the music generation system 700 also includes the storage manager 710. The storage manager 710 maintains data for the music generation system 700. The storage manager 710 can maintain data of any type, size, or kind as necessary to perform the functions of the music generation system 700. The storage manager 710, as shown in FIG. 7, includes prompt 718. The prompt 718 can include a text prompt that describes the music to be generated (e.g., by genre, tempo, etc.), as discussed in additional detail above. In some embodiments, a prompt 718 includes a history of prompts (over a particular time period, session, or other period).

As further illustrated in FIG. 7, the storage manager 710 also includes generated representation data 720. The generated representation data 720 can include visual representations, audio representations, and/or other representations of music generated by the music generation system 700. For example, generated representation data 720 can include an audio representation, a pixel representation (such as a spectrogram output of the final generated output), a latent representation, etc. In some embodiments, the generated representation 720 can include the generated music output which includes a reference music stitched together with generated music data, such as from music extension, remixing, etc. as discussed above.

The storage manager 710 may also include model input data 722 and model output data 724. The model input data 722 and model output data 724 can include the inputs and outputs of the diffusion model at each step of the diffusion process. As discussed, these may be maintained as part of the checkpointing process implemented by checkpoint manager 714 to enable memory efficient control via latent optimization.

Each of the components 702-710 of the music generation system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components as may serve a particular embodiment.

The components 702-710 and their corresponding elements can comprise software, hardware, or both. For example, the components 702-710 and their corresponding elements can comprise one or more instructions stored on a computer-readable storage medium and executable by processors of one or more computing devices. When executed by the one or more processors, the computer-executable instructions of the music generation system 700 can cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the music generation system 700 may, for example, be implemented as one or more stand-alone applications, as one or more modules of an application, as one or more plug-ins, as one or more library functions or functions that may be called by other applications, and/or as a cloud-computing model. Thus, the components 702-710 of the music generation system 700 may be implemented as a stand-alone application, such as a desktop or mobile application. Furthermore, the components 702-710 of the music generation system 700 may be implemented as one or more web-based applications hosted on a remote server. Alternatively, or additionally, the components of the music generation system 700 may be implemented in a suite of mobile device applications or “apps.”

As shown, the music generation system 700 can be implemented as a single system. In other embodiments, the music generation system 700 can be implemented in whole, or in part, across multiple systems. For example, one or more functions of the music generation system 700 can be performed by one or more servers, and one or more functions of the music generation system 700 can be performed by one or more client devices. The one or more servers and/or one or more client devices may generate, store, receive, and transmit any type of data used by the music generation system 700, as described herein.

In one implementation, the one or more client devices can include or implement at least a portion of the music generation system 700. In other implementations, the one or more servers can include or implement at least a portion of the music generation system 700. For instance, the music generation system 700 can include an application running on the one or more servers or a portion of the music generation system 700 can be downloaded from the one or more servers. Additionally or alternatively, the music generation system 700 can include a web hosting application that allows the client device(s) to interact with content hosted at the one or more server(s).

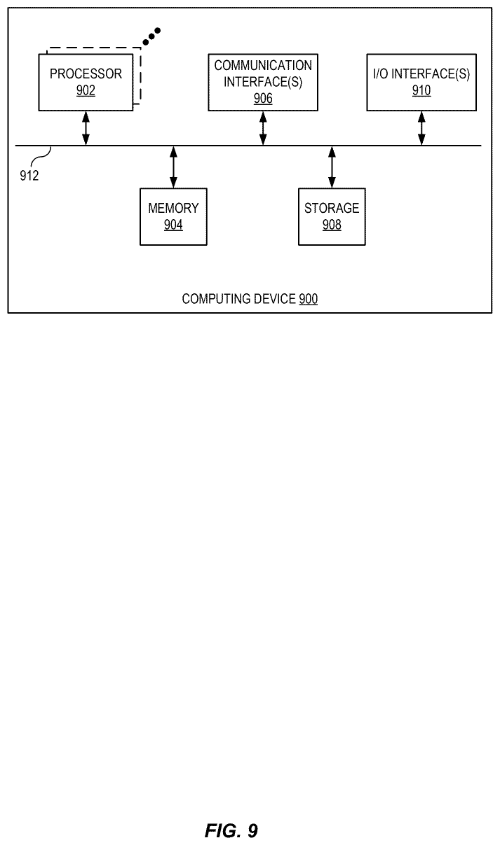

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 9. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 9.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 9.

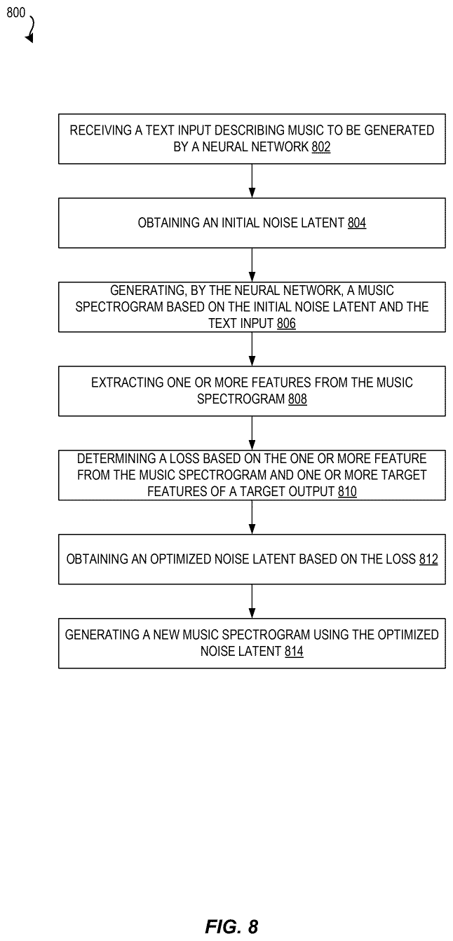

FIGS. 1-7, the corresponding text, and the examples, provide a number of different systems and devices that allow a user to generate music with inference time controls. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of music generation in accordance with one or more embodiments. In one or more embodiments, the method 800 is performed in a digital medium environment that includes the music generation system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of receiving a text input describing music to be generated by a neural network. In some embodiments, the text input can be received via a user interface (e.g., entered using a user input device via a text box, speech-to-text, etc.). The text input can describe the music to be generated by genre, mood, tempo, etc.

As illustrated in FIG. 8, the method 800 also includes an act 804 of obtaining an initial noise latent. In some embodiments, the initial noise latent may be randomly sampled from a noise space. For example, the initial noise latent may be a sample of a Gaussian random vector ~N∇(0, I).

As illustrated in FIG. 8, the method 800 also includes an act 806 of generating, by the neural network, a music spectrogram based on the initial noise latent and the text input. The neural network may be a text-to-spectrogram network or other diffusion network which receives a prompt and generates a representation of music, such as a Mel-spectrogram, or other pixel-based representation, an audio representation, a latent representation, etc. The diffusion model may generate the representation by performing a number of diffusion steps that transform the initial noise latent into the output representation.

In some embodiments, generating, by the neural network, a music spectrogram based on the initial noise latent, and the text input further includes caching inputs and outputs of the neural network at each sampling step and discarding activation values of each sampling step. This greatly reduces the memory footprint as the activation values require much more storage resources than model inputs and outputs. In some embodiments, obtaining an optimized noise latent based on the loss further includes backpropagating the loss through the neural network to determine the optimized noise latent, wherein during each sampling step the activation values are recomputed using the cached inputs and outputs of the neural network. By recalculating the activation values, these values can be obtained as needed, without requiring them to be cached (though as the cost of additional model calls).

As illustrated in FIG. 8, the method 800 also includes an act 808 of extracting one or more features from the music spectrogram. One or more feature extractors may be used depending on the features being controlled. As discussed, the music generation system may include controls for musical intensity, musical structure, melody, etc.

As illustrated in FIG. 8, the method 800 also includes an act 810 of determining a loss based on the one or more features from the music spectrogram and one or more target features of a target output. Similar to the feature extractor, the music generation system may use a loss function that corresponds to the particular feature or features being controlled, as discussed. This loss may then be backpropagated through the network to solve for an optimized noise latent.

In some embodiments, determining a loss based on the one or more feature from the music spectrogram and one or more target features of a target output, further includes receiving reference music data and extracting the one or more target features from the reference music data using one or more feature extractors corresponding to one or more feature types associated with the one or more target features. In some embodiments, the loss is determined using a loss function corresponding to the one or more feature types. In some embodiments, the one or more target features include one or more of musical intensity or musical melody.

As illustrated in FIG. 8, the method 800 also includes an act 812 of obtaining an optimized noise latent based on the loss. Once the loss has been backpropagated, the optimized noise latent can be identified. The optimized noise latent has been optimized to change the resulting generated audio based on the feature(s) being controlled. This results in fine control at inference time without requiring fine-tuning or retraining of the model. Additionally, as discussed, the checkpoint allows for memory to be managed efficiently, enabling the optimization to be solved in backpropagation.

As illustrated in FIG. 8, the method 800 also includes an act 814 of generating a new music spectrogram using the optimized noise latent. For example, a number of diffusion steps may be performed using the optimized noise latent, to generate a new representation of music. This representation can be converted into music using a vocoder. In some embodiments, depending on application, the new representation may be stitched together with reference music data to enable music extension, music remixing, looping, etc.

In some embodiments, the new music spectrogram is generated to extend reference music data and wherein the one or more target features are extracted from an overlap region of the reference music data. In some embodiments, the new music spectrogram is generated to remix a portion of reference music data and wherein the one or more target features are extracted from overlap portions of the reference music data adjacent to a remix portion.

In some embodiments, a method of music generation includes receiving a request to modify a reference music data, determining an overlap region associated with an end of the reference music data, generating, by a neural network, music data based on an initial noise latent, extracting one or more features from the music data and the overlap region, determining a loss based on the one or more features from the music data and the overlap region, obtaining an optimized noise latent based on the loss, generating new music data using the optimized noise latent, and stitching together the reference music data and the new music data.

In some embodiments, receiving a request to modify a reference music data includes receiving a request to extend the reference music data, and wherein the overlap region corresponds to an end of the reference music data. In some embodiments, receiving a request to modify a reference music data includes receiving a request to remix the reference music data. In some embodiments, the overlap region comprises a first overlap region adjacent to one end of a remix portion and a second overlap region adjacent to a second end of the remix portion.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that one or more computing devices such as the computing device 900 may implement the music generation system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a text input describing music to be generated by a neural network;
obtaining an initial noise latent;
generating, by the neural network, a music spectrogram based on the initial noise latent and the text input;
extracting one or more features from the music spectrogram;
determining a loss based on the one or more features from the music spectrogram and one or more target features of a target output;
obtaining an optimized noise latent based on the loss; and
generating a new music spectrogram using the optimized noise latent.

2. The method of claim 1, wherein generating, by the neural network, a music spectrogram based on the initial noise latent and the text input further comprises:
caching inputs and outputs of the neural network at each sampling step; and
discarding activation values of each sampling step.

3. The method of claim 2, wherein obtaining an optimized noise latent based on the loss further comprises:
backpropagating the loss through the neural network to determine the optimized noise latent, wherein during each sampling step the activation values are recomputed using the cached inputs and outputs of the neural network.

4. The method of claim 1, wherein determining a loss based on the one or more features from the music spectrogram and one or more target features of a target output, further comprises:
receiving reference music data; and
extracting the one or more target features from the reference music data using one or more feature extractors corresponding to one or more feature types associated with the one or more target features.

5. The method of claim 4, wherein the loss is determined using a loss function corresponding to the one or more feature types.

6. The method of claim 1, wherein the one or more target features include one or more of musical intensity or musical melody.

7. The method of claim 1, wherein the new music spectrogram is generated to extend reference music data and wherein the one or more target features are extracted from an overlap region of the reference music data.

8. The method of claim 1, wherein the new music spectrogram is generated to remix a portion of reference music data and wherein the one or more target features are extracted from overlap portions of the reference music data adjacent to a remix portion.

9. A non-transitory computer-readable medium storing executable instructions, which when executed by a processing device, cause the processing device to perform operations comprising:
receiving a text input describing music to be generated by a neural network;
obtaining an initial noise latent;
generating, by the neural network, a music spectrogram based on the initial noise latent and the text input;
extracting one or more features from the music spectrogram;
determining a loss based on the one or more features from the music spectrogram and one or more target features of a target output;
obtaining an optimized noise latent based on the loss; and
generating a new music spectrogram using the optimized noise latent.

10. The non-transitory computer-readable medium of claim 9, wherein the operation of generating, by the neural network, a music spectrogram based on the initial noise latent and the text input further comprises:
caching inputs and outputs of the neural network at each sampling step; and
discarding activation values of each sampling step.

11. The non-transitory computer-readable medium of claim 10, wherein the operation of obtaining an optimized noise latent based on the loss further comprises:
backpropagating the loss through the neural network to determine the optimized noise latent, wherein during each sampling step the activation values are recomputed using the cached inputs and outputs of the neural network.

12. The non-transitory computer-readable medium of claim 9, wherein the operation of determining a loss based on the one or more features from the music spectrogram and one or more target features of a target output, further comprises:
receiving reference music data; and
extracting the one or more target features from the reference music data using one or more feature extractors corresponding to one or more feature types associated with the one or more target features.

13. The non-transitory computer-readable medium of claim 12, wherein the loss is determined using a loss function corresponding to the one or more feature types.

14. The non-transitory computer-readable medium of claim 9, wherein the one or more target features include one or more of musical intensity or musical melody.

15. The non-transitory computer-readable medium of claim 9, wherein the new music spectrogram is generated to extend reference music data and wherein the one or more target features are extracted from an overlap region of the reference music data.

16. The non-transitory computer-readable medium of claim 9, wherein the new music spectrogram is generated to remix a portion of reference music data and wherein the one or more target features are extracted from overlap portions of the reference music data adjacent to a remix portion.

17. A system comprising:
a memory component; and
a processing device coupled to the memory component, the processing device to perform operations comprising:
receiving a request to modify a reference music data;
determining an overlap region associated with an end of the reference music data;
generating, by a neural network, music data based on an initial noise latent;
extracting one or more features from the music data and the overlap region;
determining a loss based on the one or more features from the music data and the overlap region;
obtaining an optimized noise latent based on the loss;
generating new music data using the optimized noise latent; and
stitching together the reference music data and the new music data.

18. The system of claim 17, wherein the operation of receiving a request to modify a reference music data comprises receiving a request to extend the reference music data, and wherein the overlap region corresponds to an end of the reference music data.

19. The system of claim 17, wherein the operation of receiving a request to modify a reference music data comprises receiving a request to remix the reference music data.

20. The system of claim 19, wherein the overlap region comprises a first overlap region adjacent to one end of a remix portion and a second overlap region adjacent to a second end of the remix portion.
